(19) United States
(12) Patent Application Publication
(10) Pub. No.: US 2006/0126839 A1
(43) Pub. Date: Jun. 15, 2006

(54) Digital broadcasting receiving apparatus

(76) Inventors: Masakazu Koike, Yokohama-shi (JP); Shinichi Ooi, Tokyo (JP); Osamu Yoshida, Kawasaki-shi (JP); Wataru Kuroiwa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/266,391

(22) Filed: Nov. 4, 2005

(30) Foreign Application Priority Data
Nov. 5, 2004 (JP) P.2004-321640

(51) Int. Cl. H04N 7/167

(52) U.S. Cl. 380/240

(57) ABSTRACT

Channel selection unit selects a channel of a desired program from a digital broadcast signal in which an ECM and an EMM are multiplexed. Separation unit separates the ECM and the EMM. EMM decoder decodes the EMM. A first key is obtained from the decoded EMM. ECM decoder decodes the separated ECM using the first key. A second key is obtained from the decoded ECM. Viewing enabling determination unit determines whether or not to enable viewing of the program. A system controller communicates with an information server through a network interface part at the time of work key non-setting, and an OSD display processing unit is made to generate an image for displaying information provided.

### RELATED APPLICATIONS

The present disclosure relates to the subject matter contained in Japanese Patent Application No. 2004-321640 filed on Nov. 5, 2004, which is incorporated herein by reference in its entirety.

### BACKGROUND

1. Field of the Invention

The present invention relates to a receiving apparatus, and particularly to a digital broadcasting receiving apparatus and method for receiving digital broadcasting signal.

2. Description of the Related Art

In digital terrestrial broadcasting services presently provided, contents are protected by a right protection method using the existing access control method in order to protect the right of a right holder. The method (hereinafter called a B-CAS method) is defined by “An access control method in digital broadcasting of standards (ARIB STD-B25 Version 4.1)” of ARIB (Association of Radio Industries and Businesses (aggregate corporation)), and is a method designed for pay broadcasting using an IC card (for example, see JP-A-4-138735).

Also, introduction of a new method specializing in right protection without having to use an IC card is being considered in the ARIB.

In a right protection method in the B-CAS method now in operation, a cryptograph and decoding key (hereinafter called a work key) for decoding an ECM (Entitlement Control Message) used in right protection is previously written into an IC card issued, so that a user can view a program immediately after buying a digital broadcasting receiving apparatus. Also, the work key is shared among broadcasting service providers.

In the new method now in consideration, in order to perform individual handling every broadcasting service provider, a work key is not written previously and operation for sending out an EMM (Entitlement Management Message) always in the broadcasting service provider is expected. In the case, a user has a period for which the work key cannot be acquired until the EMM is received, and for the period, a broadcast program cannot be viewed and an error is displayed.

The error display is a simple display built into a receiver and a detailed message could not be displayed.

### SUMMARY

In the conventional digital broadcasting receiving apparatus thus, there is a problem that a detailed message cannot be displayed at the time of a work key non-setting error.

The invention provides a digital broadcasting receiving apparatus and method capable of displaying a detailed message at the time of a work key non-setting error.

A digital broadcasting receiving apparatus includes: a channel selection unit that selects a digital signal including a channel of a desired program from a digital broadcast signal in which an ECM (Entitlement Control Message) and an EMM (Entitlement Management Message) are multiplexed; a separation unit that separates the ECM and the EMM from the digital signal selected by the channel selection unit; an EMM decoder that decodes the EMM separated by the separation unit; a first key obtaining unit that obtains a first key from the decoded EMM; an ECM decoder that decodes the ECM separated by the separation unit with the first key; a second key obtaining unit that obtains a second key from the decoded ECM; a descrambling unit that descrambles the digital signal with the second key; a viewing enabling determination unit that determines whether or not to enable viewing of the desired program based on the decoded ECM and the decoded EMM; a work key setting determination unit that determines non-setting of the first key in the decoded EMM, and determines mismatch of the first key in the decoded EMM and the second key in the decoded ECM; a network interface for that is to be connected to a computer network; a communication unit that communicates with an information server through the network interface when the work key setting determination unit determines the non-setting of the first key; an image generation unit that generates an image for displaying information provided by the information server through the communication unit; and an image output unit that outputs the image generated by the image generation unit.

### BRIEF DESCRIPTION OF THE DRAWINGS

In the accompanying drawings:

FIG. 1 is a block diagram showing a configuration of a digital broadcasting receiving apparatus according to an embodiment;

FIG. 2 is a flowchart describing a determination operation of viewing enabling determination unit;

FIG. 3 is a flowchart describing a control operation of a system controller 105 at the time when “Kw non-setting error” occurs;

FIG. 4 is a diagram showing a preservative format of an information provision URI database;

FIGS. 5A and 5B are diagrams showing an example of a display image displayed on a TV monitor;

FIGS. 6A and 6B are diagrams showing an example of a GUI image displayed on the TV monitor;

FIG. 7 is a diagram showing an example of a GUI image displayed on the TV monitor;

FIG. 8 is a flowchart describing a control operation of a system controller at the time when “Kw non-setting error” occurs;

FIG. 9 is a diagram showing an example of a GUI image displayed on a TV monitor;

FIG. 10 is a block diagram showing a configuration of a digital broadcasting receiving apparatus;

FIG. 11 is a diagram showing an area dedicated to a digital terrestrial television broadcasting service provider disposed on nonvolatile memory; and

FIG. 12 is a diagram showing an example of a GUI image displayed on a TV monitor.

### DETAILED DESCRIPTION OF THE EMBODIMENTS

Embodiments of the invention will be described below with reference to the drawings. The present invention is not limited to the embodiment described below and can be applied into various configurations.

### First Embodiment

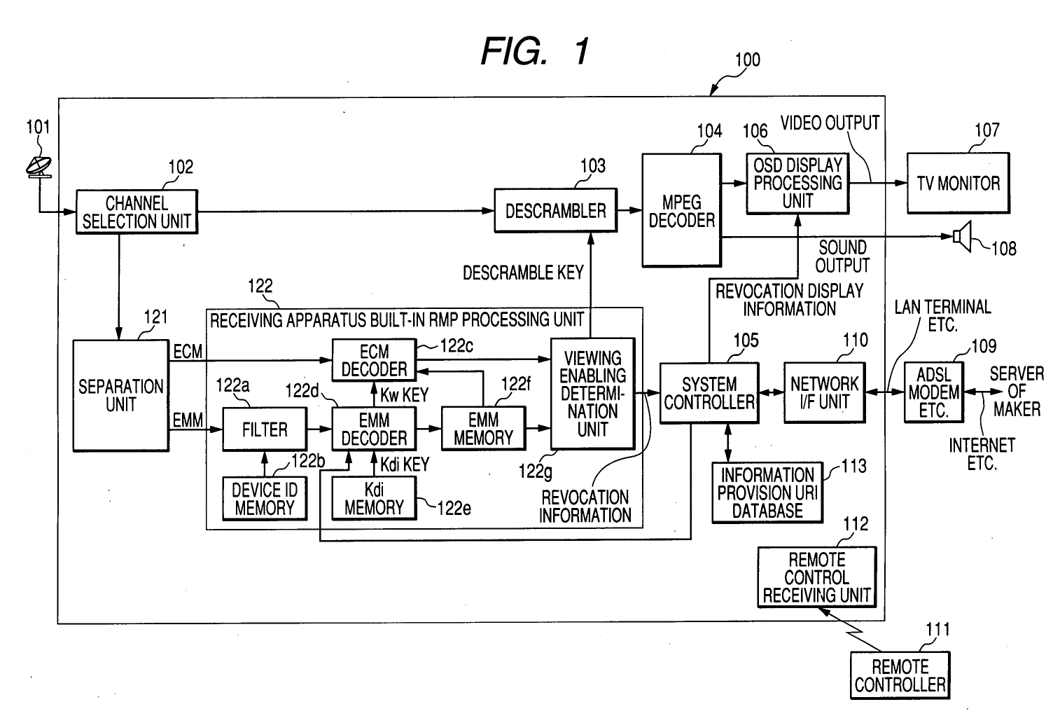

FIG. 1 is a block diagram showing a configuration of a digital broadcasting receiving apparatus according to a first embodiment.

In FIG. 1, description is made on the basis of functional blocks, and a processing unit for processing program arrangement information (SI: Service Information, PSI: Program Specific Information) essentially necessary as the receiving apparatus and a units for providing electronic program information using the program arrangement information for a viewer are omitted. In the configuration shown in FIG. 1, processing for demultiplexing an MPEG2 transport stream, processing for further decoding video and sound from a demultiplexed signal, a series of processing for outputting video and sound signals from the MPEG2 transport stream are described to be performed by an MPEG decoder 104.

As shown in FIG. 1, a digital broadcasting receiving apparatus 100 includes a channel selection unit 102 for selecting a channel of a desired program from broadcast waves input from an antenna 101 that receives a broadcast signal, a descrambler 103, an MPEG decoder 104 to which a descrambled signal from the descrambler 103 is inputted, a system controller 105 for controlling a system, an OSD (On Screen Display) display processing unit 106 to which a signal from the MPEG decoder 104 is inputted, a network I/F unit 110 having a network interface function to be connected with a computer network such as the Internet, a remote control receiving unit 112, an information provision URI database 113, a separation unit 121 for separating an ECM (Entitlement Control Message) and an EMM (Entitlement Management Message) from a signal supplied from the channel selection unit 102, and a receiving apparatus built-in RMP processing unit 122.

The RMP processing unit 122 includes a filter 122a, a device ID memory 122b for storing a device ID, an ECM decoder 122c, an EMM decoder 122d, a device key Kdi memory 122e for storing a key Kdi, an EMM memory 122f, and a viewing enabling determination unit 122g for determining whether or not to enable viewing from the ECM and the EMM.

A monitor 107 and a speaker 108 for reproducing and outputting video and sound signals, an ADSL (Asymmetric Digital Subscriber Line) modem 109, and a remote controller (remote controller) 111 for remotely operating the digital broadcasting receiving apparatus 100, are provided separately from the digital broadcasting receiving apparatus 100.

The system controller 105 is connected to the ADSL modem 109 through the network I/F unit 110 having a network interface function to be connected with a computer network such as the Internet.

The viewing enabling determination unit 122g inside the RMP processing unit 122 outputs a descramble key to the descrambler 103 in the case of determining that viewing is enabled from the ECM and the EMM. As a result, the digital broadcasting receiving apparatus 100 reproduces a program descrambled correctly. Therefore, a user can view the program.

The viewing enabling determination unit 122g inside the RMP processing unit 122 does not output a descramble key to the descrambler 103 in the case of determining that it is in a revocation state from the ECM and the EMM, and a user is disabled from viewing a program and also, revocation information indicating that it is revoked is given to the system controller 105 for controlling a system.

The digital broadcasting receiving apparatus 100 complies with a “Rights Management and Protection method” (RMP method) in which standardization is considered by ARIB (Association of Radio Industries and Businesses). In the “copyright protection method”, it is configured so that from the standpoint of protecting the right of a program provider, a scramble is used in free broadcasting and only a receiving apparatus capable of right protection of a program can demodulate the program correctly.

Thus, illegal replication of a broadcast program can be prevented. Specifically, copyright protection of a program in a receiving apparatus for digital broadcasting is achieved as shown in the following.

In the sender side of broadcasting, use conditions (right protection information) on use of a program, for example, the frequency capable of replicating a program are transmitted together with the program by broadcast waves.

The sender side of broadcasting manages a key (written as a scramble key in FIG. 1) for scrambling a program etc. or a key (written as a work key Kw in FIG. 1) for performing encryption processing in order to transmit the scramble key safely.

Further, the sender side of broadcasting manages a key (written as a device key Kdi in FIG. 1) for encrypting and transmitting the work key Kw so as to give the work key Kw to only a receiving apparatus for operating according to the use conditions shown in the right protection information, and distributes the device key Kdi to only the receiving apparatus for operating according to the use conditions shown in the right protection information.

A manufacturer of the receiving apparatus promises to provided the receiving apparatus that operates according to the use conditions shown in the right protection information and provides the distributed device key Kdi into the receiving apparatus before shipment of the receiving apparatus, or at the time of manufacturing the receiving apparatus.

In the receiving apparatus for operating according to the use conditions shown in the right protection information thus, the work key Kw and the scramble key are obtained from the given device key Kdi and a program is descrambled, and the details will be described below.

Also, in the case of outputting the descrambled program to an external connection device, only when the external connection device is also a device for operating according to the use conditions of the program shown in the right protection information, the program is configured so as to be outputted and at the time, the right protection information is added and outputted.

As described above, the right of a program provider is protected.

Next, an operation of the digital broadcasting receiving apparatus 100 shown in FIG. 1 will be described.

First, the digital broadcasting receiving apparatus 100 is connected to the antenna 101. The antenna 101 is an antenna for receiving broadcast waves and a parabolic antenna for satellite broadcasting is shown herein, but for digital terrestrial broadcasting, often used in an UHF band such as a Yagi-type antenna may be utilized. The broadcast waves received by the antenna 101 are inputted to the channel selection unit 102 of the digital broadcasting receiving apparatus 100.

The channel selection unit 102 selects a signal of a channel specified by a viewer, and performs demodulation processing, synchronous detection, error correction processing, etc., and outputs an MPEG2 transport stream to the descrambler 103 and the separation unit 121. Incidentally, the channel selection unit 102 is notified of specification of the channel from the viewer through a signal line (not shown) after a signal issued from the remote controller 111 described in FIG. 1 is received by the remote control receiving unit 112 and is analyzed by the system controller 105. Incidentally, a microcomputer is generally used as the system controller 105 herein.

The descrambler 103 performs descramble processing so that a data broadcast signal or video and sound signals of a program selected by a viewer can be viewed and used, and outputs the signals to the MPEG decoder 104. A scramble key given to the descrambler 103 is inputted from the viewing enabling determination unit 122g.

The MPEG decoder 104 decodes a signal descrambled by the descrambler 103, and outputs a video signal after decoding to the external monitor 107 through the OSD display processing unit 106, and outputs a sound signal to the external speaker 108. The monitor 107 reproduces and displays the video, and the speaker 108 reproduces and outputs the sound signal.

The OSD display processing unit 106 generates an OSD display image based on a signal from the system controller 105, and outputs the generated OSD display image and an image by a signal outputted by the MPEG decoder 104 to the monitor 107 as a combined video signal.

The receiving apparatus capable of copyright protection protects a signal after the descramble according to right protection information transmitted in program arrangement information (SI, PSI) about a broadcast signal from an output interface (not shown) and then outputs the signal. The right protection information shown herein refers to information for specifying encryption processing to a signal at the time of output or copy control information, for example, copying of the program is once, free or inhibited, and specifically refers to a digital copy control descriptor, a content use descriptor, but the right protection information may increase because of the future standardization.

Incidentally, it is assumed that the program arrangement information (SI, PSI) including the right protection information is separated from an output signal from the channel selection unit 102 in a processing unit (not shown) and the right protection information is fetched. Since it does not relate to the invention directly herein, detailed description is omitted.

The separation unit 121 separates an ECM and an EMM from a signal inputted from the channel selection unit 102, and outputs the ECM and the EMM to the RMP processing unit 122 built into the receiving apparatus.

Next, processing of the RMP processing unit 122 will be described. Incidentally, at least the ECM decoder 122c, the EMM decoder 122d, the device key Kdi storage memory 122e, the EMM memory 122f and the viewing enabling determination unit 122g among the processing of the RMP processing unit 122 are functional blocks in which software processing is often probably performed by a microcomputer.

The EMM is inputted to the filter 122a.

In the filter 122a, only an EMM for digital broadcasting receiving apparatus 100 having a device ID for the receiving apparatus is further separated and is outputted to the EMM decoder 122d. In the separation, a device ID given to the digital broadcasting receiving apparatus 100 having the device ID is used. The device ID is an ID different every maker or model of the receiving apparatus and is stored in the device ID memory 122b inside the RMP processing unit 122 before product shipment. The device ID memory 122b shall be nonvolatile memory. In the manner, only the EMM for digital broadcasting receiving apparatus 100 is separated.

The ECM is inputted to the ECM decoder 122c.

In the ECM decoder 122c, cryptograph and decoding processing of an ECM is performed and the ECM is outputted to the viewing enabling determination unit 122g. A key used in the cryptograph and decoding processing is a key Kw transmitted as a portion of information about the EMM described below.

The ECM is information including information indicating viewing conditions or a scramble key used in encryption of broadcast contents (for example, video and sound data). The information indicating viewing conditions is information for determining whether or not to enable viewing by making comparison with the EMM (individual information) described below in addition to information indicating whether broadcasting is pay broadcasting or free broadcasting, and is information indicating viewing conditions of a program.

In the EMM decoder 122d, cryptograph and decoding processing of an EMM inputted from the filter 122a is performed and the EMM is outputted to the ECM decoder 122c and the EMM memory 122f. A key used in the decoding processing is a key stored in the device key Kdi storage memory 122e before product shipment, and is different every maker or model of the receiving apparatus.

The EMM memory 122f is nonvolatile memory and the EMM in which cryptograph and decoding is performed by the EMM decoder 122d is stored. Also, the EMM memory 122f outputs the stored EMM to the viewing enabling determination unit 122g. There are cases where the EMM memory 122f also stores the key Kw (work key) described above and gives the key Kw to the ECM decoder 122c, but in FIG. 1, it is assumed that nonvolatile memory of the key Kw is present in the EMM decoder 122d for ease of seeing a triple structure of the key.

The EMM is information including at least information (revocation information) indicating whether or not the receiving apparatus having Kw is revoked, the device ID or the key Kw for decoding the ECM.

Also, the EMM is respectively stored every transport stream. It is assumed that a transport stream ID for identifying the transport stream is uniquely decided at the time of channel selection and further a database of channel selection parameters including the transport stream ID of a source of channel selection is previously created. The creation of the database can be implemented by simultaneously recording a transport stream ID described in a NIT (Network Information Table) as a parameter of a service list (receivable frequency table) in the case of initial scanning defined by, for example, technical documents (ARIB TR-B14 Version 2.0, the second edition, 6.2.1) of Association of Radio Industries and Businesses (aggregate corporation).

It is configured so that for the purpose of preventing a decrease in security, the work key Kw may be updated periodically in an updating cycle, for example, monthly and a new work key of an updating schedule is inserted into an EMM and is sent toward the receiving apparatus of all the device IDs previously at the time of updating. In a broadcasting station, the work key is updated as soon as almost all the receiving apparatus receive the EMM into which the new work key is inserted.

The EMM memory 122f supplies the key Kw corresponding to a transport stream to the ECM decoder 122c and also supplies key identification KwID to the viewing enabling determination unit 122g. At the time, an EMM is not received, so that when the key identification KwID is not stored, instead of the key identification KwID, notification indicating that the key Kw is absent is supplied to the viewing enabling determination unit 122g.

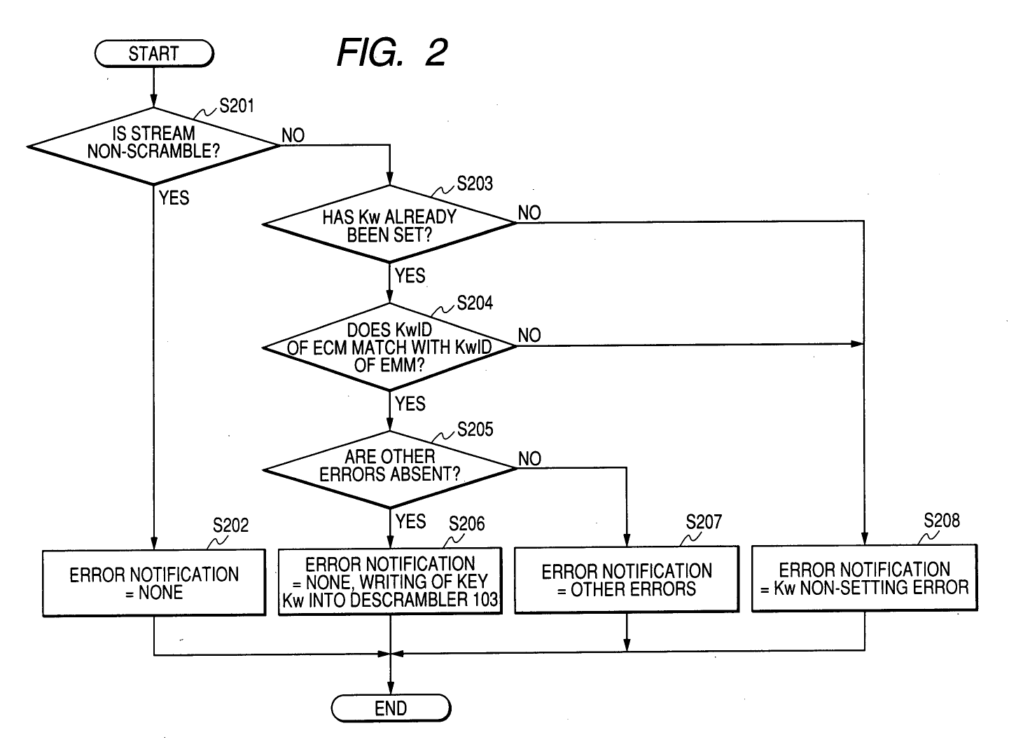

Next, a determination operation of the viewing enabling determination unit 122g will be described in detail with reference to FIG. 2.

As shown in FIG. 2, the viewing enabling determination unit 122g first performs error notification to the system controller 105 and writing of Kw into the descrambler 103.

In step S201, it is determined whether or not a transport stream is a non-scramble by referring to a scramble flag of an MPEG2 transport stream. When the transport stream is in a non-scramble state in step S201, the operation proceeds to step S202. When the transport stream is in a scramble state in step S201, the operation proceeds to step S203.

A state of the scramble flag shall be notified from the descrambler 103 to the viewing enabling determination unit 122g by a signal line (not shown).

In step S202, the processing is ended after a value “none” is set in a variable “error notification”.

In step S203, it is determined whether or not Kw has already been set in the EMM memory 122f by examining the EMM memory 122f. When Kw has already been set in the EMM memory 122f in step S203, the operation proceeds to step S204 and when Kw has not been set, the operation proceeds to step S208.

In step S204, it is determined whether or not KwID of an ECM matches with KwID stored in the EMM memory 122f. When the two KwIDs match in step S204, the operation proceeds to step S205 and when the KwIDs do not match, the operation proceeds to step S208.

In step S205, it is determined whether other errors are present or not. When the other errors are present in step S205, the operation proceeds to step S206 and when the other errors are not present, the operation proceeds to step S207.

In step S206, the processing is ended after a value “none” is set in a variable “error notification” and also the key Kw is written into the descrambler 103.

In step S207, the processing is ended after a value “other errors” is set in a variable “error notification”.

In step S208, the processing is ended after a value “Kw non-setting error” is set in a variable “error notification”.

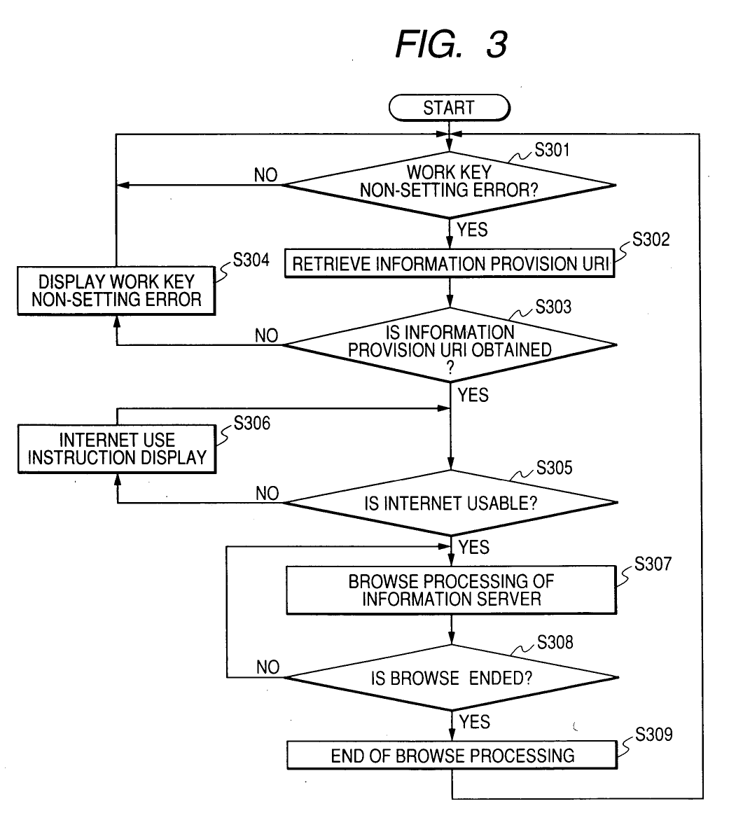

Next, a control operation of the system controller 105 at the time when “Kw non-setting error” occurs will be described using FIG. 3.

FIG. 3 is a flowchart describing a control operation of the system controller 105 at the time when “Kw non-setting error” occurs.

In step S301, it is decided whether or not a Kw non-setting error occurs by a decision as to whether or not a value “Kw non-setting error” is set in a variable “error notification”. When the Kw non-setting error is detected in step S301, the operation proceeds to step S302 and when the Kw non-setting error is not detected, the operation returns to step S301.

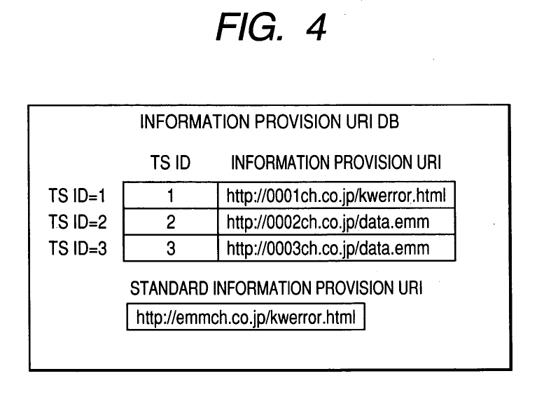

In step S302, based on a transport stream ID in which a channel is selected by the channel selection unit 102, an information provision URI (Uniform Resource Identifier) of a broadcasting service provider corresponding to the transport stream ID is previously retrieved from the information provision URI database 113 inside the digital broadcasting receiving apparatus and then, the operation proceeds to step S303. An example of a preservative format of the information provision URI database stored inside the information provision URI database 113 is shown in FIG. 4.

In step S303, it is determined whether or not the information provision URI of the broadcasting service provider corresponding to the transport stream ID in which the channel is selected is present in the information provision URI database 113 as a result of the retrieval in step S302. When the information provision URI corresponding to the transport stream ID is not found in the step S303, a standard information provision URI is retrieved. When the standard information provision URI is present, the standard information provision URI obtained is set as the information provision URI. Finally, when the information provision URI is obtained, the operation proceeds to step S305 and when it is not obtained, the operation proceeds to step S304.

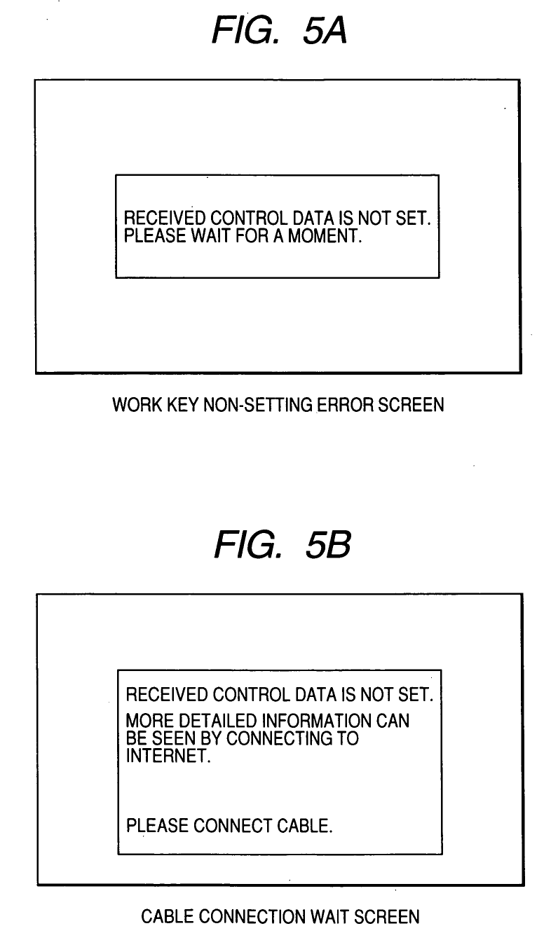

In step S304, the information provision URI is not obtained finally, so that the OSD display processing unit 106 is made to create a display image of “a message to notify a work key non-setting error” configured of characters or images, etc. as shown in FIG. 5A and is made to output video to the TV monitor 107 and then, the operation returns to step S301.

In step S305, it is determined whether or not Internet connection is available, and when it is available, the operation proceeds to step S307 and when it is not usable, the operation proceeds to step S306. As the determination method, for example, the determination is made by whether or not connection of Ethernet (registered trademark) is in a link state. The network I/F unit 110 detects whether or not the connection of Ethernet (registered trademark) is in the link state, and the result is supplied to the system controller 105 and thereby, the determination as to whether or not the Internet connection is available is made.

In step S306, the Internet is not in a usable state, so that the OSD display processing unit 106 is made to create a display image of “a message to notify promotion of Internet connection” configured of characters or images, etc. as shown in FIG. 5B and is made to output video to the TV monitor 107 and then, it waits until the Internet connection becomes usable.

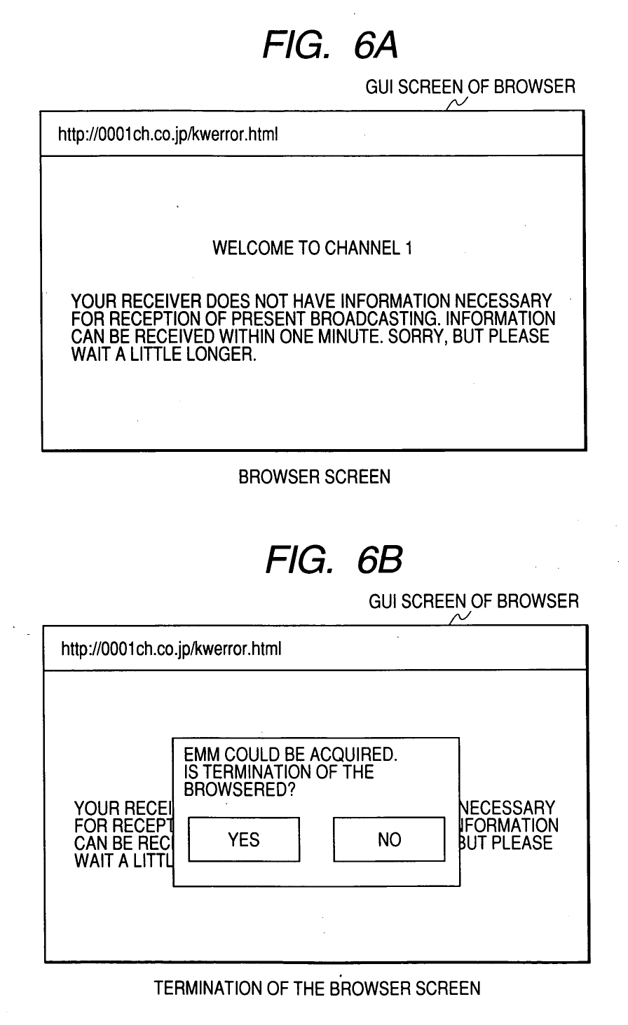

In step S307, the Internet is in the usable state, so that display of an HTML browse image of the OSD display processing unit 106 is made valid and an information provision URI is specified and browse processing is performed and then, the operation proceeds to step S308. In the browse processing, an HTML document on the corresponding information server on the Internet is read through the network I/F unit 110 and is written into the OSD display processing unit 106 as a display image by an HTML browser and, for example, an image as shown in FIG. 6A is displayed on the monitor 107.

In step S308, it is determined whether or not a user ends a browse, and when the user does not end, the operation returns to step S307 and when the user ends, the operation proceeds to step S309. For example, in step S308, when an EMM is acquired from broadcasting during Internet connection, an image for confirming the termination of the browser as shown in FIG. 6B is displayed using data obtained through the Internet.

Accordingly, a user can be prompted to return to reception of a program speedily at the time of acquiring the EMM.

In step S309, processing for ending the browse processing is performed. For example, when a user instructs the end processing of a browser in the case of displaying the image for confirming the termination of the browser as shown in FIG. 6B in step S308, the browse end processing is performed. As the termination of the browser processing, after the browse processing is ended, browser display of the OSD display processing unit 106 is erased and a normal broadcast program received image is displayed.

As described above, according to the invention, a digital broadcasting receiving apparatus capable of displaying a detailed message at the time of a work key non-setting error can be provided.

Also, according to the invention, an EMM can be acquired without waiting for reception of the EMM by broadcasting.

Also, according to the invention, a work key non-setting error is displayed by step S304, so that switching to normal error display can be done when detailed error display cannot be performed through work key non-setting communication. Also, Internet use instruction display is performed by step S306 and thereby, error display of the case incapable of communication can be performed.

Also, according to the invention, when the Internet is not usable by step S305, the Internet use instruction display is performed by step S306 and thereby, it becomes easy for a user to cope with trouble in the case of attempting to display a work key non-setting error through communication.

Also, according to the invention, by giving the information provision URI every broadcasting service provider as shown in FIG. 4, detailed display with respect to an error state can be performed every broadcasting service provider.

Various modifications of the first embodiment will be described below.

As modified example of the first embodiment, a device ID of a receiving apparatus or a transport stream ID, a network ID in channel selection may be added to a URI as a query. For example, in an information provision URI of a transport stream ID=1 in an information provision URI database shown in FIG. 4, for example, when a device ID is “0×0123456789ab”, the URI in which the device ID is inserted as such by “http://0001ch.co.jp/kwerror.html?transport_stream_id=1&device_id=0123456789ab”.

While a browse is ended since execution of browse processing in step S307 described above, the system controller 105 operates as a WWW browser and, for example, as shown in FIG. 6, a refusal note or a cautionary note about EMM acquisition in a work key non-setting error can be displayed independently without being limited to a message built into a broadcasting receiving apparatus.

Further, when a query is added to a URI, it can be configured so that a page according to the query is prepared in an information server and is displayed in the receiving apparatus side.

According to the configuration explained above, error display unique to the receiving apparatus can be performed by adding the device ID of the receiving apparatus to the information provision URI as the query and preparing the page according to the query in the information server.

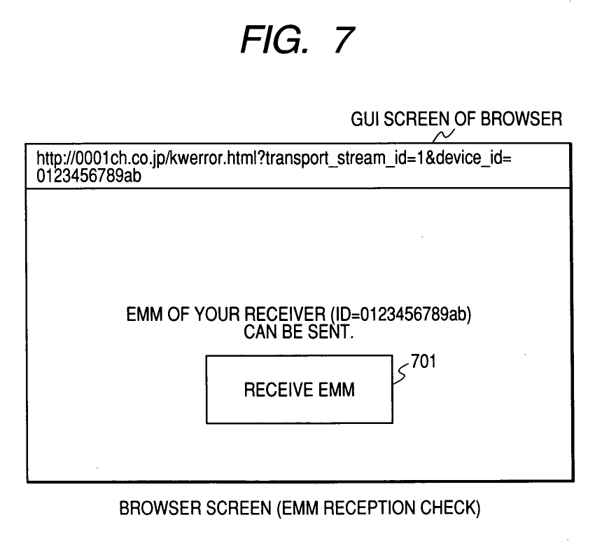

Also, data of an EMM file may be configured to be readable by an http protocol or an ftp protocol. For example, an information server sends a document in which a device ID already received by a query is embedded to the receiving apparatus side, and displays the document on the receiving apparatus side as shown in FIG. 7. A button 701 of FIG. 7 is linked to an EMM file placed on the server. When a user performs an operation for pressing the button 701, the information server sends the EMM file corresponding to the device ID of the query to the receiving apparatus.

In the receiving apparatus, the system controller 105 downloads the EMM file by browse processing. When the downloading is ended, the system controller 105 recognizes that it is the EMM file from, for example, an extension (.emm) of the file, and supplies an EMM included in the downloaded EMM file to the RMP processing unit 122, and performs processing similar to that at the time of receiving the EMM by broadcasting below.

Accordingly, the EMM can be obtained through the server before the EMM is received through broadcasting.

The EMM may be configured to be acquired directly.

In the receiving apparatus side, the system controller 105 accesses the information provision URI database 113 of, for example, a transport stream ID=2 shown in the example of FIG. 4, and downloads an EMM file “data.emm” from an information server “0002ch.co.jp” directly. When reading of the EMM file is ended, the system controller 105 displays an image for confirming the termination of the browser for a user and performs processing in a manner similar to the case of acquiring the EMM through broadcasting during Internet connection.

In the first embodiment, an extension of a file name has been used as a method for recognizing that it is a type of EMM file. However, various other methods can be used. For example, content-type described in RFC1945 “Hyper Text Transport Protocol-HTTP/1.0” issued from IETF (Internet Engineering Task Force) can be defined and specified. In the case, it is executed by passing data from a browser to an application (for example, RMP processing) according to content-type.

In the first embodiment, HTML browser display has been performed based on the URI, but a URI of an EMM file may be specified directly as the URI. Further, in the case, it is unnecessary to perform browser display since the EMM file can be read directly.

In the first embodiment, the information provision URI has been specified every transport stream. However, it is not necessarily specified thus and it may be only a URI of a standard provision server.

There may be configured that no standard information provision URI. In the case, when information provision URI information having the corresponding transport stream ID is not registered in step S302 of FIG. 3, it is considered that the information provision URI is not present, and display of step S304 is performed and the processing is ended.

In the first embodiment, the device ID has been sent as the query, but it is not limited to the as long as the device ID can be recognized and, for example, there may be a URI in which directory names or file names are divided uniquely every device ID.

There may be implemented as a form in which a device ID is not specified as an EMM file and files including plural EMM files are read from an information server and filtering is performed by RMP processing from among the read files.

In the first embodiment, a confirmation (FIG. 6B) by an image of the termination of the browser at the time of receiving an EMM in browser execution or at the time of ending reading of an EMM file can be omitted in implementation, and it may be configured so as to perform the next processing by immediately considering that a browse is ended.

Similarly, a confirmation as to whether or not Internet connection can be made, step S305 or step S306 of FIG. 3 can be omitted in implementation.

In the first embodiment, as information for confirming whether or not Internet connection can be made, the description has been made by taking the method for using a link state of a network as an example. In addition, the presence or absence of connection of a cable, the presence or absence of a specific display address, and a method for sending and receiving a packet to an HTTP proxy server or any server actually and making a confirmation in the response state are contemplated.

In the first embodiment, as the error notification method, notification has been provided by image display, but it is not limited to this configuration and notification may be provided by sound. In the case, a sound processing unit is disposed and a well-known sound output is produced based on control of a system controller.

The contents of processing in configuration blocks in the first embodiment can partially be implemented by a computer controlled by a software program product. The software in the case includes programs or data, and achieves the advantages the same of the embodiment described above by physically utilizing hardware of the computer, and a preferred conventional art is applied to a portion to which a conventional art can be applied. Further, concrete kinds or configurations of hardware or software for implementing the invention, the scope processed by software may be arbitrary selected. A program product that implements the invention by operating a computer is also within the scope of the present invention.

### Second Embodiment

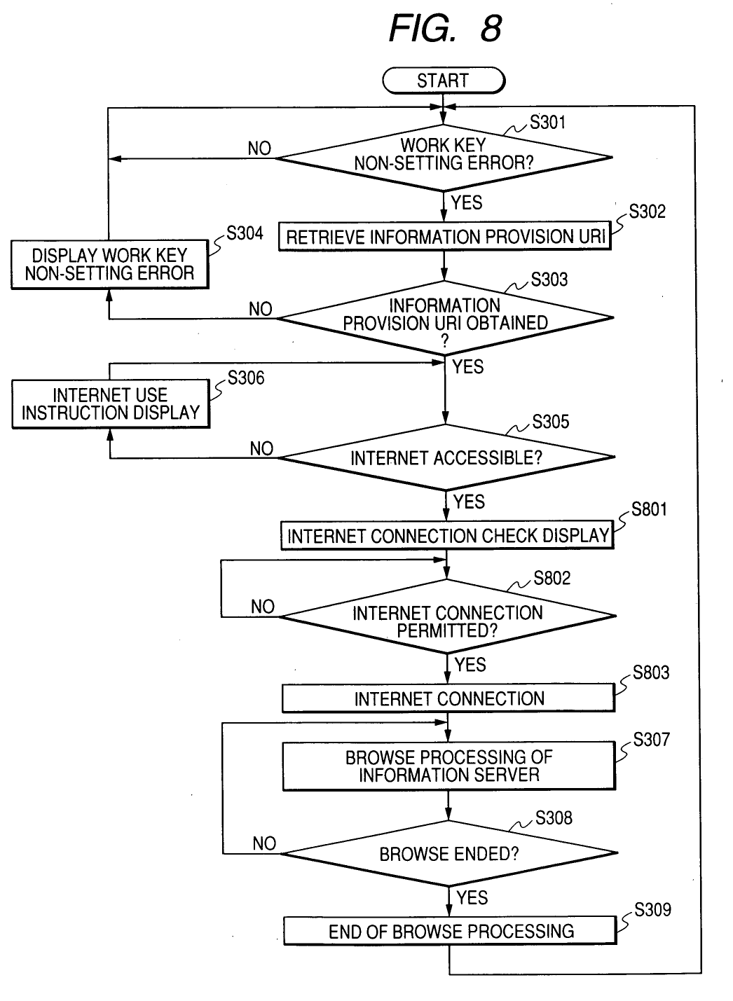

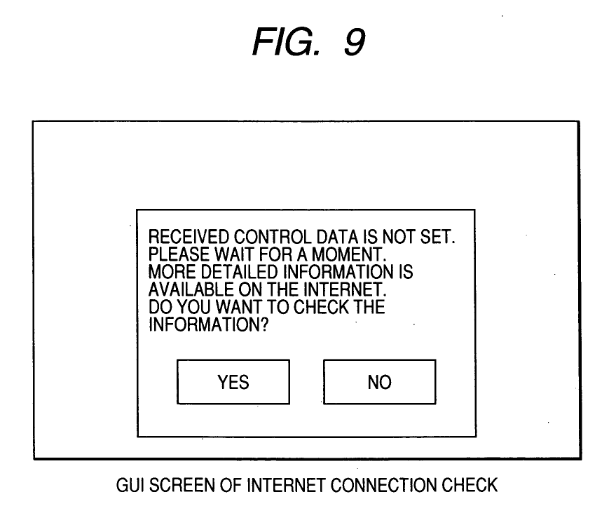

Next, a second embodiment of the invention will be described in detail with reference to FIGS. 8 and 9.

The second embodiment is an embodiment in which it is inquired whether or not to actually connect to the Internet after the Internet usable determination in the first embodiment, and only a different portion will be described.

A control operation of a system controller 105 at the time when “Kw non-setting error” occurs will be described.

FIG. 8 is a flowchart describing a control operation of the system controller 105 at the time when “Kw non-setting error” occurs. In FIG. 8, steps S801 to S803 are newly added between step S305 and step S307 as compared with FIG. 3.

In step S305, it is determined whether or not Internet connection is available, and when it is available, the operation proceeds to step S801 and when it is not usable, the operation proceeds to step S306.

In step S801, an OSD display processing unit 106 is controlled so as to display a GUI image for confirming and selecting whether or not to make connection to the Internet as shown in FIG. 9 for inquiring whether or not to actually connect to the Internet.

When a user permits the connection in step S802, the operation proceeds to step S803 and when the user does not permit, the operation returns to step S802.

In step S803, processing for actually connecting to the Internet is performed and the operation proceeds to step S307. Subsequent to step S307, the processing subsequent to browse display processing is performed in a manner similar to the first embodiment.

As described above, according to the invention, a digital broadcasting receiving apparatus capable of displaying a detailed message at the time of a work key non-setting error can be provided.

Further, as an advantage peculiar to the second embodiment, a user can decide whether or not to make connection to the Internet before connection to the Internet is made, so that an effect capable of limiting network connection time can be obtained. For example, it is effective in the case of charging on an as-used basis for network connection time.

Also, according to the second embodiment, communication time in the case of performing error processing through communication can be reduced by connecting to the Internet in step S803 in the case that connection to the Internet is permitted in step S802.

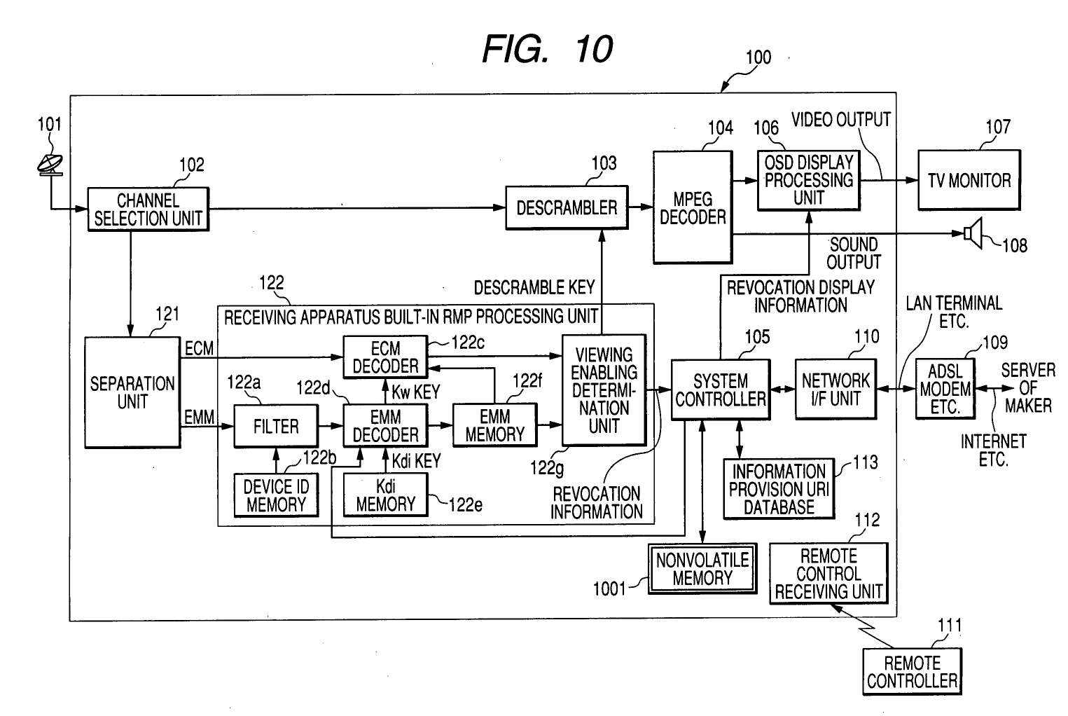

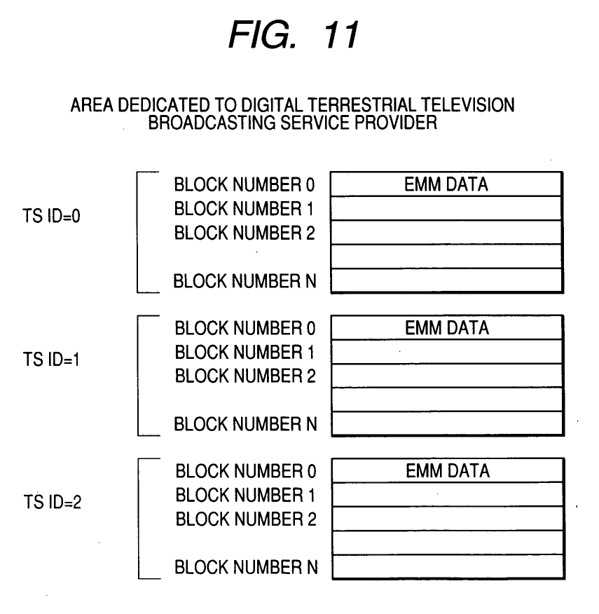

### Third Embodiment Next, a third embodiment will further be described in detail with reference to FIGS. 10 and 11.

In the third embodiment, the first embodiment is modified and only a portion different from the first embodiment will be described.

FIG. 10 is a block diagram showing a configuration of a digital broadcasting receiving apparatus according to the third embodiment of the invention. As compared with the configuration shown in FIG. 1, a nonvolatile memory part 1001 which a system controller 105 can access is added.

The system controller 105 stores an EMM file in the nonvolatile memory 1001 shown in FIG. 10. At the time of the preservation control, the system controller 105 stores the EMM file in separate directories every network ID as shown in FIG. 11.

The nonvolatile memory 1001 is set in an area dedicated to a digital terrestrial television broadcasting service provider defined by, for example, ARIB TR-14, 5.2 of the third edition. The area is defined every broadcasting service provider and a file is identified by a block number, and a specific block number is defined as an EMM file preservation area and the digital broadcasting receiving apparatus stores an EMM in the corresponding block as an EMM file.

In the case of acquiring an EMM by browsing an HTML image of an information server based on an operation shown in the first embodiment, an EMM file is stored in a block number 0 of the nonvolatile memory 1001. The storage processing is performed by a script language embedded in an HTML document. It is assumed that a script language of a browser is extended so that a pseudo browser object according to an extension function for broadcasting defined by ARIB STD-B24 Version 4.0, the second edition, 7.5 can be used and, for example, at least the following two functions are implemented.

1) writePersistentArray( ) for reading of numerical data from nonvolatile memory

2) readPersistentArray( ) for writing of numerical data into nonvolatile memory

When the EMM file is written into the nonvolatile memory 1001 by the script language, the system controller 105 detects the written EMM file and an EMM included in the EMM file is supplied to a RMP processing unit 122. For the supplied EMM, the RMP processing unit 122 performs processing similar to that of the EMM sent by broadcasting.

As described above, according to the embodiment, a digital broadcasting receiving apparatus capable of displaying a detailed message at the time of a work key non-setting error can be provided.

Further, as an advantage peculiar to the second embodiment, in the system controller 105, normal receiving processing of the receiving apparatus including RMP processing is separated from browse processing and the existing nonvolatile memory normally mounted in the digital broadcasting receiving apparatus is used for passing an EMM, so that the embodiment has good compatibility with a configuration of the digital broadcasting receiving apparatus.

### Fourth Embodiment

Next, a fourth embodiment will be described.

In the fourth embodiment, the first embodiment is modified and only a portion different from the first embodiment will be described.

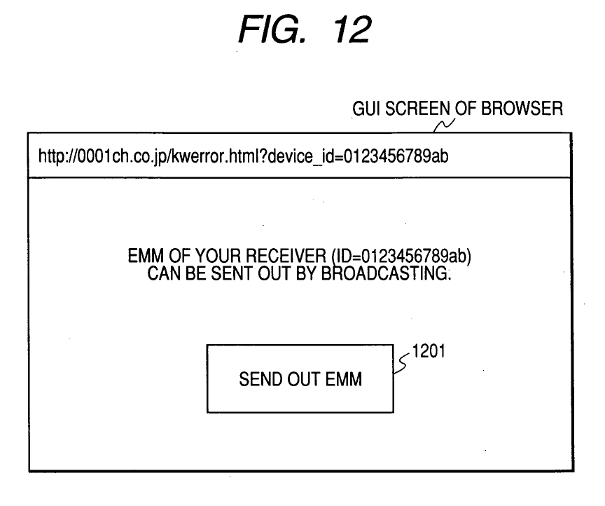

A digital broadcasting receiving apparatus 100 specifies a URI in which a device ID is added to an information server URI as a query, and performs browse processing. The browse processing follows an HTML description and, for example, display as shown in FIG. 12 is performed. When a user presses a button 1201 on display of a browser, information about the button and the device ID are sent to an information server, and the information server makes a request to a broadcasting system (not shown) so as to preferentially send an EMM having the corresponding device ID. The broadcasting system receives the request, and retrieves the corresponding EMM, and multiplexes the EMM as a broadcast signal, and sends out the EMM speedily.

Accordingly, the digital broadcasting receiving apparatus 100 can receive the EMM speedily.

As described above, according to the invention, a digital broadcasting receiving apparatus capable of displaying a detailed message at the time of a work key non-setting error can be provided.

Further, as an advantage peculiar to the fourth embodiment, an operation in which a user presses the button is specifications of an HTML browser, so that processing can be performed without extending the specifications of the HTML browser of the digital broadcasting receiving apparatus.

### Fifth Embodiment

Next, a fifth embodiment will be described.

In the fifth embodiment, the first embodiment is modified and only a portion different from the first embodiment will be described.

In the fifth embodiment, a power of the network I/F unit 110 is turned off along with a termination of a browser when the browser is terminated by reception of an EMM during network connection in the first embodiment. For example, a system controller 105 controls the power of a network I/F unit 110 and thereby, the control is performed.

As described above, according to the fifth embodiment, a digital broadcasting receiving apparatus capable of displaying a detailed message at the time of a work key non-setting error can be provided.

Further, as an advantage peculiar to the fifth embodiment, when it becomes unnecessary to acquire an EMM by network connection, a power is turned off speedily and power consumption of devices can be reduced.

Also, according to the fifth embodiment, the power of the network I/F unit is turned off along with the stop of the browser, so that power consumption at the time of performing error processing through communication can be reduced.

As described above with reference to the embodiments, a digital broadcasting receiving apparatus capable of displaying a detailed message at the time of a work key non-setting error can be provided.

Although specific embodiments are described in the above, the present invention is not limited to the embodiments as described above, and when implementing the embodiments to an actual product, components can be modified and embodied without departing from the gist. Also, various configurations can be applied by proper combinations of plural components disclosed in the embodiments. For example, some components may be deleted from the configurations shown in the embodiments. Further, components in the different embodiments may be combined properly.

It is to be understood that the invention is not limited to the specific embodiments described above and that the invention can be embodied with the components modified without departing from the spirit and scope of the invention. The invention can be embodied in various forms according to appropriate combinations of the components disclosed in the embodiments described above. For example, some components may be deleted from all components shown in the embodiment. Further, the components in different embodiments may be used appropriately in combination.

What is claimed is:

1. A digital broadcasting receiving apparatus comprising:
a channel selection unit that selects a digital signal including a channel of a desired program from a digital broadcast signal in which an ECM (Entitlement Control Message) and an EMM (Entitlement Management Message) are multiplexed;
a separation unit that separates the ECM and the EMM from the digital signal selected by the channel selection unit;
an EMM decoder that decodes the EMM separated by the separation unit;
a first key obtaining unit that obtains a first key from the decoded EMM;
an ECM decoder that decodes the ECM separated by the separation unit with the first key;
a second key obtaining unit that obtains a second key from the decoded ECM;
a descrambling unit that descrambles the digital signal with the second key;
a viewing enabling determination unit that determines whether or not to enable viewing of the desired program based on the decoded ECM and the decoded EMM;
a work key setting determination unit that determines non-setting of the first key in the decoded EMM, and determines mismatch of the first key in the decoded EMM and the second key in the decoded ECM;
a network interface for that is to be connected to a computer network;
a communication unit that communicates with an information server through the network interface when the work key setting determination unit determines the non-setting of the first key;
an image generation unit that generates an image for displaying information provided by the information server through the communication unit; and
an image output unit that outputs the image generated by the image generation unit.

2. The digital broadcasting receiving apparatus according to claim 1, further comprising:
a connection state determination unit that determines whether or not the network interface is connected and accessible to the computer network; and
an EMM obtaining unit that obtains the EMM from the information server through the network interface, when the connection state determination unit determines that the network interface is connected and accessible to the computer network and when the work key setting determination unit determines the non-setting of the first key in the decoded EMM,
wherein the EMM decoder decodes the EMM obtained by the EMM obtaining unit.

3. The digital broadcasting receiving apparatus according to claim 1, further comprising:
a connection state determination unit that determines whether or not the network interface is connected and accessible to the computer network; and
an output unit that outputs information indicating that the first key is not set, when the connection state determination unit determines that the network interface is inaccessible to the computer network and when the work key setting determination unit determines the non-setting of the first key in the decoded EMM.

4. The digital broadcasting receiving apparatus according to claim 3, further comprising:
a detection unit that detects whether or not the EMM is acquired from the digital signal; and
a controller that stops an output of the output unit when the detection unit detects that the EMM is acquired.

5. The digital broadcasting receiving apparatus according to claim 3, further comprising a display that displays the information output by the output unit.

6. The digital broadcasting receiving apparatus according to claim 1, further comprising:
a connection state determination unit that determines whether or not the network interface is connected and accessible to the computer network; and
an output unit that outputs information for prompting connection to the computer network, when the connection state determination unit determines that the network interface is inaccessible to the computer network and when the work key setting determination unit determines the non-setting of the first key in the decoded EMM.

7. The digital broadcasting receiving apparatus according to claim 6, further comprising:
a detection unit that detects whether or not the EMM is acquired from the digital signal; and
a controller that stops an output of the output unit when the detection unit detects that the EMM is acquired.

8. The digital broadcasting receiving apparatus according to claim 6, further comprising a display that displays the information output by the output unit.

9. The digital broadcasting receiving apparatus according to claim 1, wherein the information server stores a plurality of IDs that is unique to each of a plurality of broadcasting service providers, and
wherein the communication unit receives from the information server the information for each of the broadcasting service providers that are identified by the IDs.

10. The digital broadcasting receiving apparatus according to claim 1, further comprising:
a detection unit that detects whether or not the EMM is acquired from the digital signal; and
a controller that stops an output of the image output unit when the detection unit detects that the EMM is acquired.

11. The digital broadcasting receiving apparatus according to claim 1, further comprising:
a detection unit that detects whether or not the EMM is acquired from the digital signal; and
a controller that stops connection to the computer network by the network interface when the detection unit detects that the EMM is acquired.

12. The digital broadcasting receiving apparatus according to claim 1, further comprising:
an ID sending unit that sends an ID unique to the receiving apparatus to the information server through the network interface; and
a unique information receiving unit that receives information unique to the receiving apparatus sent from the information server in response to the ID unique to the receiving apparatus.

13. The digital broadcasting receiving apparatus according to claim 1, further comprising:
an ID sending unit that sends an ID unique to each of plurality of broadcasting service providers to the information server through the network interface; and
a unique information receiving unit that receives information unique to the broadcasting service provider sent from the information server in response to the ID unique to the broadcasting service provider.

14. The digital broadcasting receiving apparatus according to claim 1, further comprising a display that displays the image output by the image output unit.

15. A method for receiving a digital broadcasting comprising:
selecting a digital signal including a channel of a desired program from a digital broadcast signal in which an ECM (Entitlement Control Message) and an EMM (Entitlement Management Message) are multiplexed;
separating the ECM and the EMM from the selected digital signal;
decoding the separated EMM;
obtaining a first key from the decoded EMM;
decoding the separated ECM with the first key;
obtaining a second key from the decoded ECM;
descrambling the digital signal with the second key;
determining whether or not to enable viewing of the desired program based on the decoded ECM and the decoded EMM;
determining non-setting of the first key in the decoded EMM;
determining mismatch of the first key in the decoded EMM and the second key in the decoded ECM;
communicating with an information server when the work the non-setting of the first key is determined;
generating an image for displaying information provided by the information server; and
outputting the image generated by the image generation unit.
